(19) United States
(12) Patent Application Publication
(10) Pub. No.: US 2019/0210047 A1
(43) Pub. Date: Jul. 11, 2019

(54) PAINT DELIVERY SYSTEM

(71) Applicant: David Glynn Richardson, JR., Crowley, TX (US)

(72) Inventor: David Glynn Richardson, JR., Crowley, TX (US)

(21) Appl. No.: 16/126,179

(22) Filed: Sep. 10, 2018

Related U.S. Application Data
(63) Continuation-in-part of application No. 14/877,626, filed on Oct. 7, 2015, now abandoned.

(51) Int. Cl. B05B 7/24; B05C 17/00; B44D 3/12; B05B 7/30

(52) U.S. Cl. CPC B05B 7/241; B05B 7/30; B44D 3/12; B05C 17/002

(57) ABSTRACT

A paint delivery system includes a container forming an inner area; an insert having a cylindrical top of a first diameter and a cylindrical bottom of a second diameter and being tapered from the top to the bottom, the insert further having a lip extending around the top; and a tightening device extending through the lip to secure the insert within the inner area of the container by securing the lip to a top of the container; a paint dispenser having an elongated siphoning means to extend within the container and insert and to extract paint from within the insert; the insert and siphoning means create a pressure differential within the insert that facilitates extraction of the paint from the insert.

### BACKGROUND

### 1. Field of the Invention

The present invention relates generally to paint delivery systems, and more specifically, to a paint delivery system for paint sprayers.

### 2. Description of Related Art

Paint delivery systems are well known in the art and are effective means to store, consolidate, and dispense material. For example, FIG. 1 depicts a conventional paint delivery system 101 having a container 103 filled with paint 105 and a paint dispenser 107 with a siphoning means 109. During use, the paint dispenser 107 extracts the paint 105 from the container 103 via the siphoning means 109.

One of the problems commonly associated with system 101 is its limited use. For example, the internal geometry of container 103 does not facilitate the siphoning means 109 to extract all the paint 105 from the system 201.

Prior art attempts to mitigate this limitation have included an integral or insertable recess 111 designed to pool the paint 105 towards the siphoning means 109. However, integral recess 111 solutions increase the costs and limit alternate uses for container 103, while insert recess 111 solutions are unstable in the container 103 and difficult to extract from the container 103 when not in use.

Accordingly, although great strides have been made in the area of paint delivery systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a cross-sectional side view of a common paint delivery system;

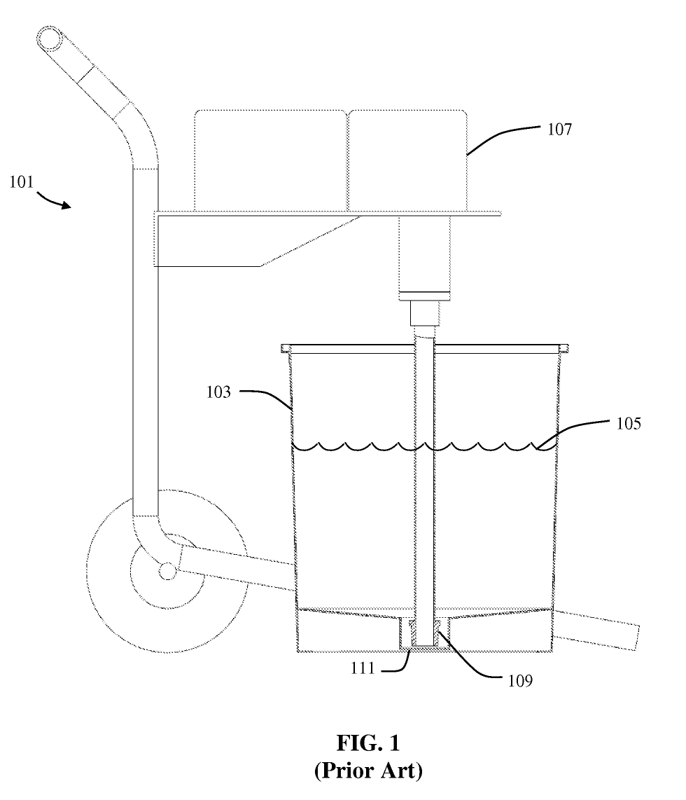

FIG. 2 is a cross-sectional side view or a paint delivery system in accordance with a preferred embodiment of the present application;

FIG. 3 is an isometric view of the insert of FIG. 2;

FIG. 4 is a flowchart depicting a preferred process of the system of FIG. 2;

FIG. 5 is a side view of a paint delivery system in accordance with an alternative embodiment of the present application;

FIG. 6 is a side view of the insert of FIG. 5;

FIG. 7 is a top view of the insert of FIG. 5.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with container systems. Specifically, the system facilitates extraction of paint from the system while preserving the versatility and ease of use of all system components. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

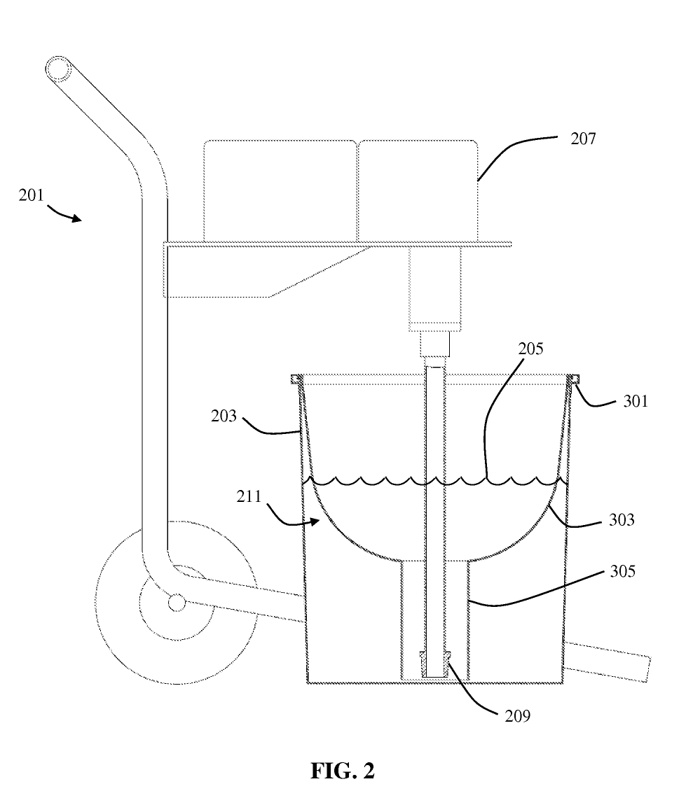

Referring now to the drawings wherein like reference characters identify corresponding or similar elements throughout the several views, FIG. 2 depicts a cross-sectional side view of a paint delivery system 201 in accordance with a preferred embodiment of the present application. It will be appreciated that system 201 overcomes one or more of the above-listed problems commonly associated with conventional paint delivery systems.

In the preferred embodiment system 201 comprises a container 203 wholly or partially filled with paint 205 in communication with a paint dispenser 207 via a siphoning means 209, and a container insert 211 in secure communication with the container 203. During use, the insert 211 secures to the rim of the container 203 and the siphoning means 209 extends through an opening 305 in the insert 211 toward the base of the container 203 to extract the paint 205.

One of the unique features believed characteristic of the present application is that insert 211 enables the siphoning means 209 to create a pressure differential (not shown) that facilitates extraction of the paint 205 from the container 203.

Another of the unique features believed characteristic of the present application is the versatility of use. For example, insert 211 can be placed in container 203 either before or after the introduction of paint 205 to the system 201 and can be easily removed from the system 201 without the need to extend any appendages or tools into the paint 205. Further, because insert 211 can be removed from container 203, container 203 may be used for less specific purposes than paint delivery if and when desired.

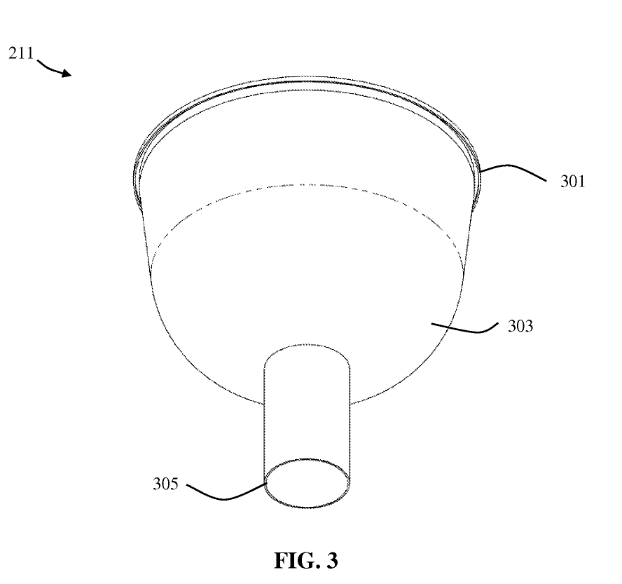

Referring now to FIG. 3 an isometric view of insert 211 is shown, comprising a lip 301, a tapered portion 303, and an opening 305. In the preferred embodiment, lip 301 secures to the rim of container 203 and opening 305 is near but not flush with the base of container 203 (see FIG. 2).

Although a funnel shape for insert 211 is shown, it is contemplated that any shape, dimensions, and positioning can be used so long as they generally create a pressure differential to help drive the paint 205 into the siphoning means 209. For example, it is contemplated that insert 211 can be constructed as a universal fit adaptable to all container sizes or specially constructed to create an airtight seal when in communication with a specific container size.

Another of the unique features believed characteristic of the present application is that lip 301 enables insert 211 to secure firmly to the rim of container 203 such that insert 211 does not move or tilt while system 201 is in use.

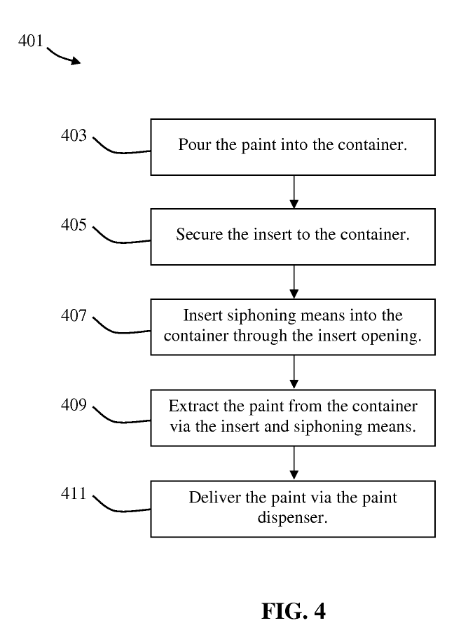

In FIG. 4, a flowchart 401 depicts a preferred process of system 201. The user assembles the components of the system 403, 405, 407 to create a pressure differential that assists the siphoning means in extracting the paint from the bucket 409 for delivery by the dispenser 411. Although FIG. 4 shows the placement of the insert after filling the container with paint, it will be appreciated that these two steps are be interchangeable.

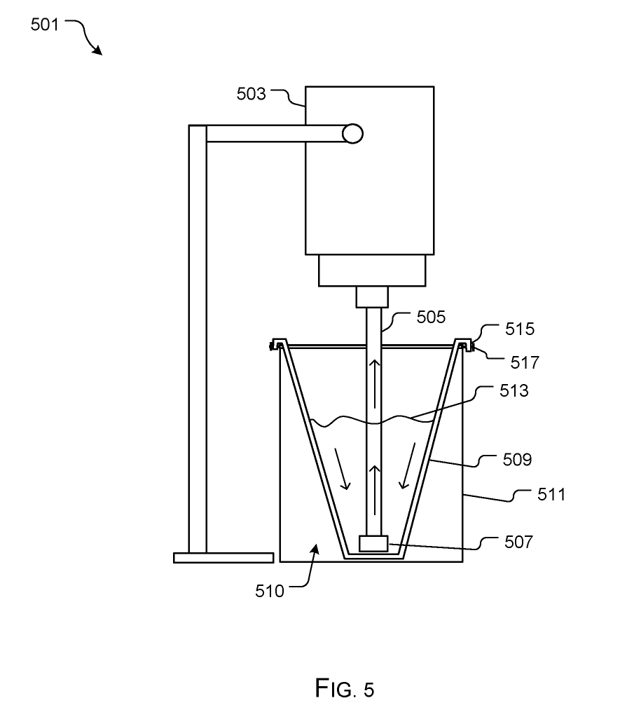

In FIG. 5, a side view depicts an alternative embodiment of a paint delivery system 501 in accordance with a preferred embodiment of the present application, system 501 includes a paint dispenser 503 with an inlet 505 in communication with a filter 507 configured to be positioned at a bottom of an insert 509 within an inner area 510 of a container 511. Paint dispenser 503 pulls paint 513 via filter 507 and inlet 505, wherein the paint can be used in a spray apparatus. In system 501, insert 509 can include a lip 515 configured to extend up and over a top of container 511, and can further include one or more wing nuts 517 or similar tightening device configured to tighten insert 509 to container 511. It should be appreciated that this feature provides a means for the insert to be secured in place.

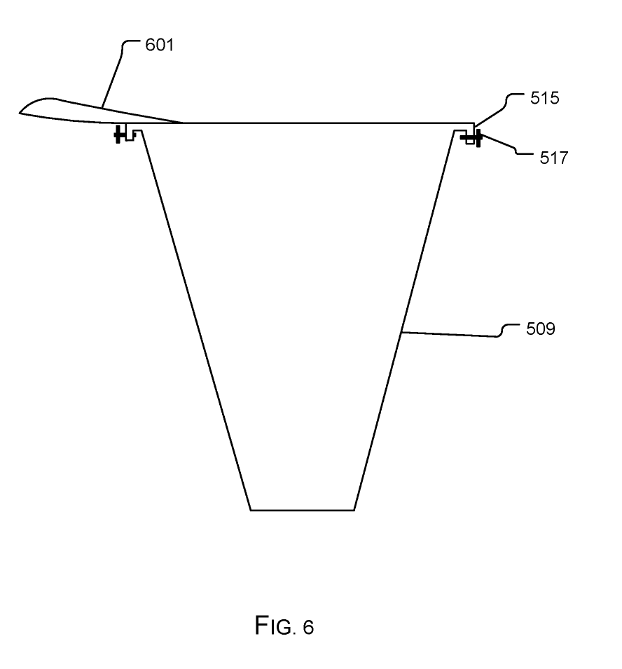

Insert 509 is further shown in FIG. 6, having an optional fluid channel 601 secured to lip 515 and configured to allow paint to flow into insert 509. In this Figure, lip 515 and wing nuts 517 are further shown for more clarity. It should be appreciated and understood that insert 509 is tapered from a top 701 to a bottom 703, wherein the bottom has a diameter less than the top, thereby funneling paint toward the filter positioned at/near the bottom.

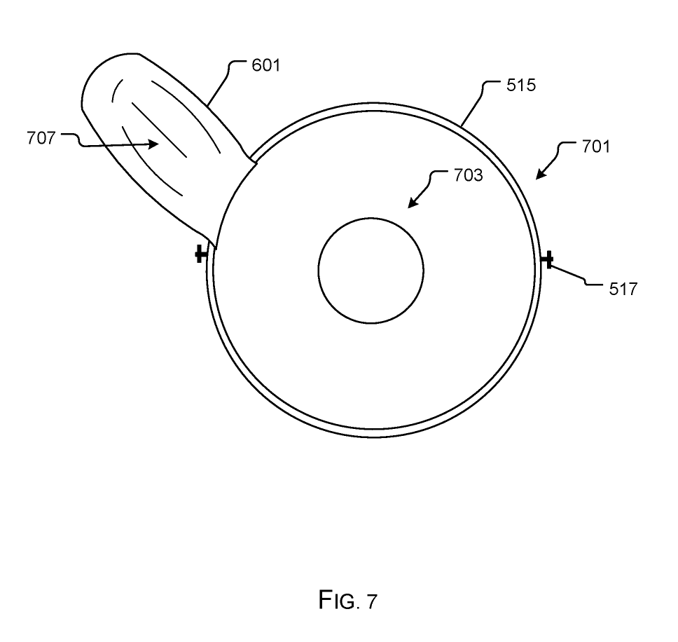

In FIG. 7, a top view further shows channel 601 attached to lip 515 and configured to channel fluid into insert 509. It should be appreciated that channel 601 can have a concave bottom surface 707 to direct the paint and/or fluid flow.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A paint delivery system, comprising:
a container forming an inner area;
an insert having a cylindrical top of a first diameter and a cylindrical bottom of a second diameter and being tapered from the top to the bottom, the insert further having:
a lip extending around the top; and
a tightening device extending through the lip and configured to secure the insert within the inner area of the container by securing the lip to a top of the container;
a paint dispenser having an elongated siphoning means configured to extend within the container and insert and configured to extract paint from within the insert;
wherein the insert and siphoning means create a pressure differential within the insert that facilitates extraction of the paint from the insert.

2. The system of claim 1, wherein the lip of the insert is configured to curve to an outside of the container and secure thereto via the tightening means.

3. The system of claim 1, further comprising:
a channel having a concave bottom surface and connected to the lip of the insert;
wherein the channel is configured to direct fluid flow into the insert.

3. The system of claim 1, wherein the tightening means comprises:
a wingnut configured to tighten to the container.

4. A method, comprising:
providing the paint delivery system of claim 1;
placing the paint inside the insert;
securing the insert to the container;
inserting the siphoning means into the insert;
extracting the paint from the insert via the siphoning means; and
delivering the paint via the paint dispenser.
